(19) United States
(12) Patent Application Publication
(10) Pub. No.: US 2005/0097557 A1
(43) Pub. Date: May 5, 2005

(54) Methods and apparatus for making web browser act like stand-alone application

(75) Inventors: Andrew John Bradfield, Cortlandt Manor, NY (US); James Sargent Lipscomb, Yorktown Heights, NY (US); Oun Zhou, Cortlandt Manor, NY (US)

Correspondence Address: Ryan, Mason & Lewis, LLP, 90 Forest Avenue, Locust Valley, NY, 11560, US

(73) Assignee: International Business Machines Corporation, Armonk, NY (US)

(21) Appl. No.: 10/699,036

(22) Filed: Oct. 31, 2003

(51) Int. Cl. G06F 9/46

(52) U.S. Cl. 718/102; 718/103

(57) ABSTRACT

Techniques for processing information, associated with an information source, in accordance with a browser are provided. In a first aspect of the invention, the technique includes obtaining information from the information source, and preventing a user from interacting with a displayed first portion of the received information until after a second portion of the received information is sufficiently loaded. In a second aspect of the invention, the technique includes obtaining information from the information source in accordance with an application, and preserving data provided in accordance with a user while interacting with a first portion of the application before loading a second portion of the application requested by the user.

### FIELD OF THE INVENTION

The present invention relates to client/server technologies and their methods of communication. More particularly, the present invention relates to how Internet web browsers handle information from the server when rendering a request from a client.

### BACKGROUND OF THE INVENTION

As is well known in a distributed information network such as the Internet, a user employs a client computer system (hereinafter “client”) to access information over the network from one or more content serving computer systems (hereinafter “servers”) associated with one or more information sources.

The computer software program that runs on the client that enables the user to interact with a server is known as a “web browser” (“web” being short for World Wide Web). The web browser receives and loads content, in the form of web pages, from a server and displays the web pages to the user. The web browser also receives input from the user and causes the input to be sent to the server. Typically, web pages are authored in HyperText Markup Language (HTML) as part of a computer software program that is known generally as an “application.”

It is known that problems may arise when a user attempts to interact with a web page that has not yet been fully loaded by a web browser. When a web browser displays a page, it does not do so all at once. The web browser receives an HTML file, or the first part of the file, and begins to interpret what the file means, starting at the beginning of the file. As the web browser goes along through the file, it displays what it has figured out so far to the user, and in most cases, elements in the page that are active are ready for the user to click, even if the part of the page that tells what to do has not yet been processed by the web browser. An error will then result. When the web browser completes processing of the HTML page, including references outside the page, and displays it in its entirety, the page is fully loaded. Only then may one be assured of the correct functioning of an interaction that has code elsewhere in the page that processes the interaction.

One way of preventing interactions with partially loaded pages is to display a web page in table form, which gives the user a blank screen until the entire page is loaded. However, this can be quite frustrating to the user. Another way of preventing interactions with partially loaded pages is to place code between <script></script> tags at the top of the HTML document (in the <head> block), so that the code is preloaded before it is run. Another approach preloads “mouse-over” images (i.e., part of a web page that cause a change in the page display when the user's mouse pointer passes over it). However, these approaches are application-specific and thus do not provide a general solution for a majority of situations.

Another problem that is known to exist with conventional web browsers is that, while applications are stateful in nature (i.e., one program state depends on another program state), such web browsers are typically designed to be stateless.

Preserving state for simple applications (such as electronic commerce or “e-commerce” applications) over the web has been handled in a number of ways. Cookies can save a small amount of state on the client, and the browser uniform resource locator (URL) string can likewise be extended to contain as much state as can be squeezed into a few hundred characters. However, such approaches do not scale to large, complex data items.

Therefore, techniques are needed for improved handling of information received from a server.

### SUMMARY OF THE INVENTION

The present invention provides techniques for improved handling of information received from an information source such as a server.

In a first aspect of the invention, a technique for processing information, associated with an information source, in accordance with a browser, comprises the steps/operations. Information is obtained from the information source. A user is prevented from interacting with a displayed first portion (e.g., a first frame) of the received information until after a second portion (e.g., a second frame) of the received information is sufficiently loaded.

The first portion may at least partially depend on the second portion. The preventing step/operation may further comprise instructing the user to wait to interact with the first portion until after the second portion is sufficiently loaded. The preventing step/operation may further comprise rendering the first portion inactive until after the second portion is sufficiently loaded. The second portion may be sufficiently loaded when it is fully loaded. The browser may be implemented on a client computer system. The browser may comprise a web browser. The information source may comprise at least one server computer system.

In a second aspect of the invention, a technique for processing information, associated with an information source, in accordance with a browser, comprises the steps/operations. Information is obtained from the information source in accordance with an application. Data provided in accordance with a user is preserved while interacting with a first portion of the application before loading a second portion (e.g., subapplication) of the application requested by the user. The preserving step/operation may further comprise storing the user provided data in at least one of a session object and a hidden frame.

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a block diagram illustrating a client-server system architecture in accordance with which the present invention may be implemented;

FIG. 2 is a flow diagram illustrating a client-based methodology for avoiding errors when interacting with partially loaded pages, according to a first embodiment of the present invention;

FIG. 3 is a flow diagram illustrating a client-based methodology for avoiding errors when interacting with partially loaded pages, according to a second embodiment of the present invention;

FIG. 4 is a flow diagram illustrating a client-based methodology for preserving state, according to an embodiment of the present invention; and

FIG. 5 is a block diagram illustrating a hardware implementation of a computer system in accordance with which one or more components/methodologies of the present invention may be implemented according to an embodiment of the present invention.

### DETAILED DESCRIPTION OF PREFERRED EMBODIMENTS

The following description will illustrate the invention in the context of an Internet/World Wide Web environment. It should be understood, however, that the invention is not limited to use with any particular information network environment. The invention is instead more generally applicable for use with any information network environment in which it is desirable to better handle information received from an information source.

As will be explained in illustrative detail herein, the present invention provides a framework for creating an application that is essentially stand-alone, yet is delivered on a web browser. The techniques of the invention give a web browser some advantages of a stand-alone application by removing or reducing some user-perceived differences between the two. This is accomplished by making the web application maintain state and gracefully handle user interactions with pages that are still loading as the user tries to interact.

“Standalone applications” are native-code applications that install onto a computer and run. Programming in the native-code of the computer allows the application programmer tight control over basic functions, for example, the ability to lock out interaction until display is complete. Examples of standalone applications are word-processing programs, spreadsheet programs, and most computer games.

Operation of a web browser, in accordance with the invention, is modified via software code that is sent from the server. The actual main browser programs (e.g., iexplore.exe for Internet Explorer and netscape.exe for Netscape) are not changed. The browser simply acts on the software code that is sent from the server. Thus, the method by which the browser handles user interaction is code-driven. Therefore, the code received from the server, and how the code logic is structured, are what make the browser act like a stand-alone application.

A “web application” is an application that accesses the server via the web. The client code sent to a user's browser from the server makes up the web application. The browser simply renders the code sent by the server. Stand-alone applications handle the rendering and business logic within the application.

There are many advantages associated with a web browser, as compared to a stand-alone application, that make an application developed for a web browser significantly beneficial. First, no installation is necessary. That is, the user already has a web browser. Furthermore, anywhere the user visits will likely also already have a web browser, so the application may be run there too. The web browser environment is already client-server enabled for large applications involving database access. Web communication protocols are already in place and standardized, such as the Transmission Control Protocol/Internet Protocol (TCP/IP), to deliver data between the client and the server.

Thus, by using the existing client-server framework of the web in accordance with the present invention, developers will be able to implement cost effective solutions by securing data and preserving states on a client machine rather than having to develop applications that must be installed.

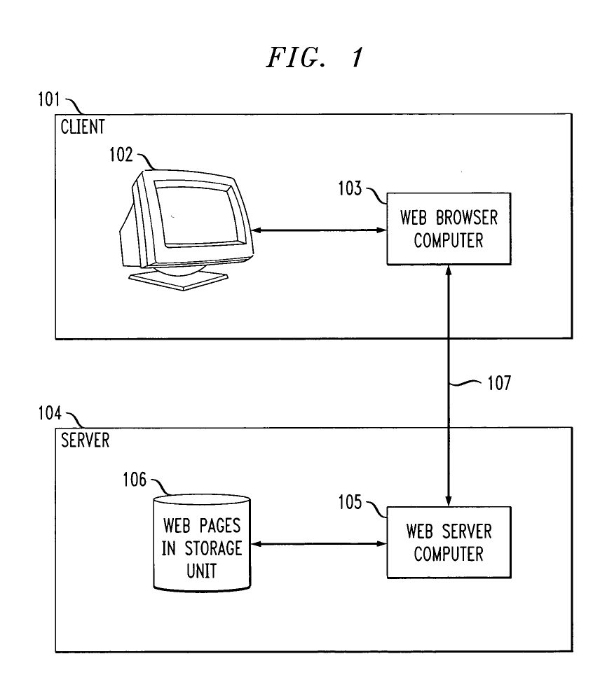

Referring initially to FIG. 1, a block diagram illustrates a client-server system architecture in accordance with which the present invention may be implemented. The architecture will first be used to illustrate some problems with existing content serving and rendering approaches followed by a detailed description of the techniques and advantages of the present invention which overcome these and other problems.

As shown, a client computer system 101 generally includes a monitor 102 and a web browser computer 103. Server computer system 104 generally includes a web server computer 105 and a web page storage unit 106.

Web applications have problems that stand-alone applications do not.

Code is sent from the server 104 to the client 101 over the Internet (107) so that the client's browser 103 can then render the page on the user's monitor 102. Even when a page appears to have completely loaded, the server 104 may still be in the process of sending program code to complete the client's 101 request. When the user acts quickly and interacts with a web page while it is still loading, errors are possible since the client 101 may be missing portions of the code. For example, a user clicks on a button and nothing happens. If the code for the function behind the button did not reach the client 101 before the click occurred, no-response behavior would be the result.

Another problem is that web browsers 103 by their nature are stateless, whereas applications are filled with state. Each interaction with a web browser 103 is by default a new interaction with the server 104, unrelated to previous interactions. This is a problem when a multi-step user interaction is needed, for example, for purchasing an item and charging to a credit card. Existing methods of coaxing the browser 103 to preserve state do not scale to large, complex data items.

As will be readily understood from the illustrative explanations to follow, one advantage of the invention is that interactions are selectively prevented when the page is partially loaded thereby avoiding errors. For example, a page may have two frames, and in this case, Frame #1 depends on Frame #2's information to continue working. In this case, it would be preferable to have a mechanism to determine if Frame #1 depends on Frame #2. If Frame #1 is dependent on Frame #2, the code prevents the user from working on Frame #1 until Frame #2 is completely loaded. Failure to do so would result in an error due to an incomplete code base on the client 101. Performance is greatly improved if there is no dependency between Frame #1 and Frame #2, since users can interact with the page before loading is complete.

Another advantage is to maintain state in client-server 101,104 environments where the preserved state comprises large data objects. For example, a web application has multiple subapplications. When a user is working on subapplication #1, which requires the user to enter a large amount of information, it may be useful to gather information from subapplication #2 in order to complete subapplication #1's page. When returning from subapplication #2, the user expects all of the information they have already entered into subapplication #1 to be saved. The state preservation mechanism of the invention preserves data between subapplications so interactions between subapplications are seamless to the end user.

1. Avoiding Errors when Interacting with Partially Loaded Pages

In accordance with the present invention, selectively preventing a page that is partially loaded from producing errors may be accomplished in several ways.

1.1 Show a Live Frame

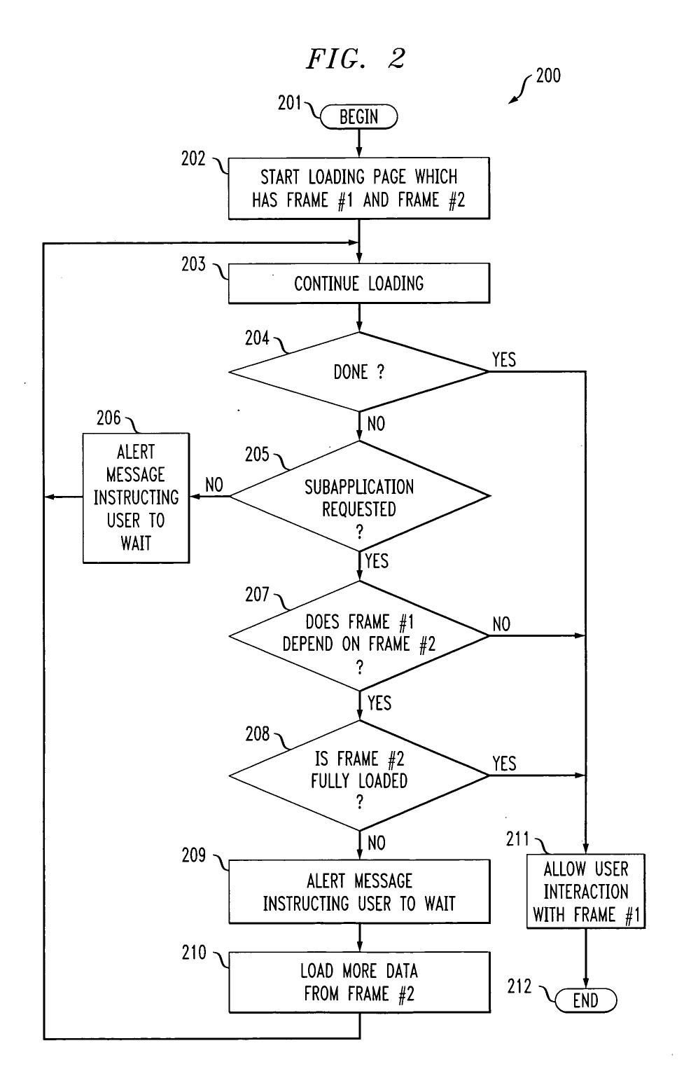

Referring now to FIG. 2, a flow diagram illustrates a client-based methodology 200 for avoiding errors when interacting with partially loaded pages, according to a first embodiment of the present invention. It is to be appreciated that methodology 200 may be implemented by software code received by the client from the server. Generally, in this embodiment, a live frame is shown to the user at the client (via monitor 102), however, interactions are intercepted and the user is asked to try again (to interact) when the page fully loads. A “live frame” refers to a frame that is active, i.e., the user can interact with (e.g., click on hyperlinks, enter data, select items, etc.).

When the user sends a request (step 201) to the server 104 to access a web page, the page begins loading (step 202).

In some special case, Frame #1 depends on Frame #2's information to continue (step 207). It is very common that Frame #1 is already activated, and Frame #2 is still in the process of loading (step 208). To determine if the user can continue working on Frame #1, the methodology checks if Frame #1 depends on Frame #2 (step 207). If no dependency is found, the user can be allowed to interact with Frame #1 (step 211). If a dependency exists between Frame #1 and Frame #2, a check is made to determine whether Frame #2 is fully loaded (step 208). If loaded, the user is allowed to work with Frame #1 (step 211) and so on. If not loaded, the user is instructed via an alert message to wait (step 209), while Frame #2 continues loading (step 210).

The browser 103 continues to load more data from Frame #2. If the user tries to interact with Frame #1 (step 204) during this process, e.g., a subapplication is requested (step 205), an alert message pops up to tell the user to wait until the page is fully loaded (step 206). Once the user has addressed the alert message, Frame #2 keeps loading (step 203). This process continues until the page has completely loaded (end block 212).

Thus, advantageously, if Frame #1 and Frame #2 are fully loaded or if Frame #1 does not depend on Frame #2, then the user is allowed to interact with Frame #1. However, if Frame #2 depends on Frame #1 and Frame #2 is not fully loaded, or if the user requests a subapplication (e.g., associated with Frame #2), then the user is instructed to wait until Frame #2 fully loads.

1.2 Show a Dead Frame

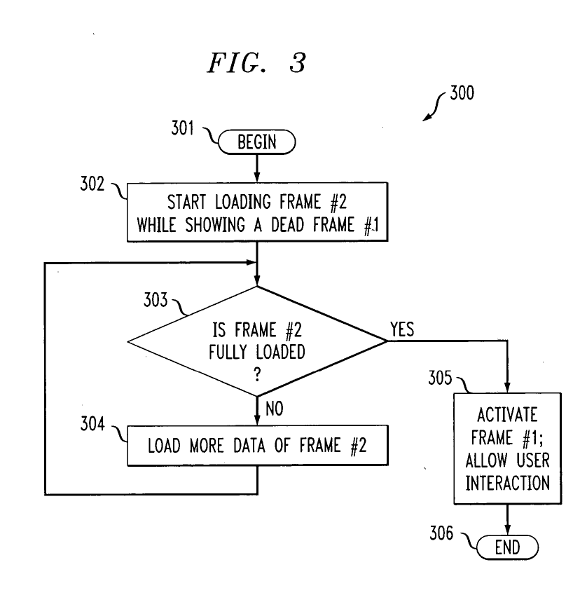

Referring now to FIG. 3, a flow diagram illustrates a client-based methodology 300 for avoiding errors when interacting with partially loaded pages, according to a second embodiment of the present invention. It is to be appreciated that methodology 300 may be implemented by software code received by the client from the server. Generally, in this embodiment, a dead frame is shown to the user at the client (via monitor 102) until the page fully loads. A “dead frame” refers to a frame that is inactive, i.e., the user can not interact with (e.g., can not click on hyperlinks, can not enter data, can not select items, etc.).

Suppose a web application has a web page whose content and structure is similar to that of the live frame (FIG. 2) example outlined above. Frame #1 has a small amount of data and Frame #2 has a large amount of data. When the user accesses the page (step 301), Frame #2 begins loading on the client's browser 103 and Frame #1 is disabled (step 302). Until Frame #2 is fully loaded (step 303), Frame #1 is not active (i.e., dead frame), and Frame #2 continues to load (step 304). If Frame #2 is fully loaded (step 303), Frame #1 is then activated (step 305). The user is now allowed to interact with Frame #1. The methodology ends (end block 306).

A comparison of these two implementations highlights the difference between a live frame approach (FIG. 2) and a dead frame approach (FIG. 3). A live frame approach checks if there are any dependencies while loading the page, while a dead frame approach does not check for dependencies. Assuming no dependency issues exist, a live frame approach allows users to continue working even as part of the page is still loading. A dead frame approach totally blocks the user from continuing to working until the page has completely loaded.

2. Preserving State

Neither cookies nor URL string methods (as mentioned in the background section above) scale to large e-commerce applications, which need to adopt an implementation for storing large amounts of data.

In accordance with the invention, two illustrative state preservation approaches for storing large amounts of data may comprise: (1) using a session object; and/or (2) using a hidden frame.

A session object is an object that implements some business logic running on the server 104. For each active user, the server 104 maintains a session object, which contains the user's persistent data throughout the life of the user's session. It has the advantage that the data is stored on the server 104, which allows clients 101 to avoid storing large amounts of data into a hidden frame. As more data is stored on the client machine 101, the chance of data loss due to a client's browser 103 crashing increases. When the session object is used to store data, an application is able to take advantage of the built-in safe guards and backup plans implemented by the server 104 to prevent data loss. Even though the session object is a more robust solution than the hidden frame for large amounts of data, it too can crash in extreme circumstances. A Java Virtual Machine (JVM) located on the server 104 can become bogged down with data and cause the server 104 to crash.

A hidden frame occurs in a frameset in which one frame takes up 100% of the display so that the user can not see another (hidden) frame, which may contain data. A hidden frame has the advantage of off-loading the data to each client 101, which in turn reduces the strain on the server 104. For clients 101 with low bandwidth connections, this solution can greatly improve the speed of the application because of the decreased size and number of requests to the server 104 for data.

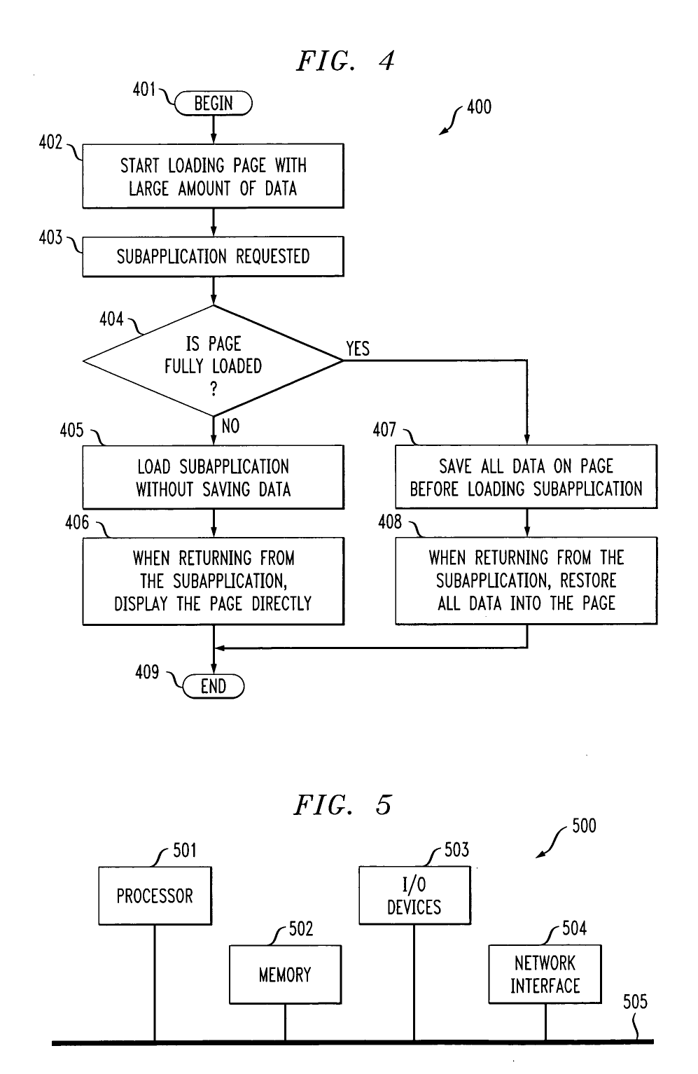

Either or both of these state preservation mechanisms can be used to store data in the following methodology described in the context of FIG. 4. For example, the web browser may handle state via the hidden frame and the URL, and the server may handle state via the session object.

Referring now to FIG. 4, a flow diagram illustrates a client-based methodology 400 for preserving state, according to an embodiment of the present invention. It is to be appreciated that methodology 400 may be implemented by software code received by the client from the server.

Suppose a very complicated web application has several subapplications. The user can jump back and forth among these subapplications. In one of these subapplications, assume that there is a page that has a large amount of data entered by the user. The present invention is used to save the data in the page before jumping to other subapplications. Later, when the user returns, the entire data the user typed in can be recovered.

As shown in FIG. 4, a user interacts (e.g., accesses different page/subapplication) with a page containing a large amount of data which needs to be preserved (step 401). The page starts to load (step 402). At the point of user interaction (e.g., subapplication request in step 403), the methodology checks whether the page has been fully loaded (step 404). If the page is fully loaded, the data is saved before loading the subapplication, and the requested subapplication is loaded (step 407). When the user comes back from a subapplication, all of the data that was saved is recovered (step 408).

Going back to step 404, if the page is not fully loaded, the requested subapplication is loaded directly without saving data, since the user has not entered any data (step 405). Thus, the subapplication is loaded regardless of whether the user entered data. If the data was not saved before the subapplication was loaded, the page is displayed directly (step 406). The methodology ends at end block 409.

The problem of partial loading is widely known, yet with small pages that load quickly or contain only pure text, the problem rarely occurs. While the invention may be used in accordance with any applications, use of the invention is particularly desirable for complex applications or when high reliability is important. The inventive solution provides a way to use existing software, i.e., the web browser, to achieve the same results as a stand-alone application along with some additional benefits.

Referring finally to FIG. 5, a block diagram illustrates an illustrative hardware implementation of a computer system in accordance with which one or more components/methodologies of the present invention (e.g., components/methodologies described in the context of FIGS. 1 through 4) may be implemented, according to an embodiment of the present invention. For instance, such a computer system in FIG. 5 may implement a client computer system 101 (FIG. 1) and/or a server computer system 104 (FIG. 1). Thus, the illustrative methodologies described in the context of FIGS. 2, 3 and 4 may be implemented on the computer system shown in FIG. 5.

It is to be understood that such individual components/methodologies may be implemented on one such computer system, or on more than one such computer system. In the case of an implementation in a distributed computing system, the individual computer systems and/or devices may be connected via a suitable network, e.g., the Internet or World Wide Web. However, the system may be realized via private or local networks. The invention is not limited to any particular network.

As shown, computer system 500 may be implemented in accordance with a processor 501, a memory 502, I/O devices 503, and a network interface 504, coupled via a computer bus 505 or alternate connection arrangement.

It is to be appreciated that the term “processor” as used herein is intended to include any processing device, such as, for example, one that includes a CPU (central processing unit) and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc.

In addition, the phrase “input/output devices” or “I/O devices” as used herein is intended to include, for example, one or more input devices (e.g., keyboard, mouse, etc.) for entering data to the processing unit, and/or one or more output devices (e.g., speaker, display, etc.) for presenting results associated with the processing unit.

Still further, the phrase “network interface” as used herein is intended to include, for example, one or more transceivers to permit the computer system to communicate with another computer system via an appropriate communications protocol.

Accordingly, software components including instructions or code for performing the methodologies described herein may be stored in one or more of the associated memory devices (e.g., ROM, fixed or removable memory) and, when ready to be utilized, loaded in part or in whole (e.g., into RAM) and executed by a CPU.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

1. A method of processing information, associated with an information source, in accordance with a browser, the method comprising the steps of:
obtaining information from the information source; and
preventing a user from interacting with a displayed first portion of the received information until after a second portion of the received information is sufficiently loaded.

2. The method of claim 1, wherein the first portion at least partially depends on the second portion.

3. The method of claim 1, wherein the preventing step further comprises instructing the user to wait to interact with the first portion until after the second portion is sufficiently loaded.

4. The method of claim 1, wherein the preventing step further comprises rendering the first portion inactive until after the second portion is sufficiently loaded.

5. The method of claim 1, wherein the second portion is sufficiently loaded when it is fully loaded.

6. The method of claim 1, wherein the browser is implemented on a client computer system.

7. The method of claim 1, wherein the browser comprises a web browser.

8. The method of claim 1, wherein the information source comprises at least one server computer system.

9. A method of processing information, associated with an information source, in accordance with a browser, the method comprising the steps of:
obtaining information from the information source in accordance with an application; and
preserving data provided in accordance with a user while interacting with a first portion of the application before loading a second portion of the application requested by the user.

10. The method of claim 9, wherein the preserving step further comprises storing the user provided data in at least one of a session object and a hidden frame.

11. The method of claim 9, further comprising the step of retrieving the preserved data when the user returns to the first portion of the application.

12. The method of claim 9, wherein the preserving step is performed when the first portion of the application is sufficiently loaded.

13. The method of claim 9, wherein the first portion of the application is sufficiently loaded when it is fully loaded.

14. The method of claim 9, wherein the browser is implemented on a client computer system.

15. The method of claim 9, wherein the browser comprises a web browser.

16. The method of claim 9, wherein the information source comprises at least one server computer system.

17. Apparatus for processing information, associated with an information source, in accordance with a browser, the apparatus comprising:
a memory; and
at least one processor coupled to the memory and operative to: (i) obtain information from the information source; and (ii) prevent a user from interacting with a displayed first portion of the received information until after a second portion of the received information is sufficiently loaded.

18. Apparatus for processing information, associated with an information source, in accordance with a browser, the apparatus comprising:
a memory; and
at least one processor coupled to the memory and operative to: (i) obtain information from the information source in accordance with an application; and (ii) preserve data provided in accordance with a user while interacting with a first portion of the application before loading a second portion of the application requested by the user.

19. An article of manufacture for processing information, associated with an information source, in accordance with a browser, comprising a machine readable medium containing one or more programs which when executed implement the steps of:
obtaining information from the information source; and
preventing a user from interacting with a displayed first portion of the received information until after a second portion of the received information is sufficiently loaded.

20. An article of manufacture for processing information, associated with an information source, in accordance with a browser, comprising a machine readable medium containing one or more programs which when executed implement the steps of:
obtaining information from the information source in accordance with an application; and
preserving data provided in accordance with a user while interacting with a first portion of the application before loading a second portion of the application requested by the user.
